(19) United States
(12) Patent Application Publication
(10) Pub. No.: US 2013/0238508 A1
(43) Pub. Date: Sep. 12, 2013

(54) SYSTEMS AND METHODS FOR COLLABORATIVE VIRTUAL PRODUCT DEVELOPMENT

(71) Applicants: Raymond Kok, East Windsor, NJ (US); Ian Fisher, Long Beach, CA (US); Eric Leeson, Mason, OH (US); Ori Ben-Haim, Huntington Beach, CA (US)

(72) Inventors: Raymond Kok, East Windsor, NJ (US); Ian Fisher, Long Beach, CA (US); Eric Leeson, Mason, OH (US); Ori Ben-Haim, Huntington Beach, CA (US)

(73) Assignee: Siemens Product Lifecycle Management Software Inc., Plano, TX (US)

(21) Appl. No.: 13/787,992

(22) Filed: Mar. 7, 2013

Related U.S. Application Data
(60) Provisional application No. 61/608,586, filed on Mar. 8, 2012.

(51) Int. Cl. G06Q 10/10

(52) U.S. Cl. CPC G06Q 10/101
USPC 705/300

(57) ABSTRACT

Various disclosed embodiments include systems and methods for collaborative virtual product development. According to disclosed embodiments, a system includes a collaborative design associated with a virtual product, the collaborative design including a plurality of design elements representing units of data which include attributes, positions, and geometries of the virtual product. The collaborative design also references a plurality of partitions defined as a hierarchical organization of the design elements. The collaborative design also includes at least one workset comprising a subset of the design elements possessing memberships in the workset based on one or more predetermined rules. The workset is configured to enable a user to modify the collaborative design. The system includes a search application configured to search the design elements and operable to generate the subset based on the predetermined rules.

### CROSS REFERENCE TO RELATED PATENT APPLICATIONS

The present application claims priority pursuant to 35 U.S.C. 119(e) to the following U.S. provisional patent application which is incorporated herein by reference in its entirety for all purposes: U.S. Provisional Patent Application No. 61/608,586, entitled “COMPONENT-BASED LIFECYCLE MANAGEMENT FOR 3D VIRTUAL PRODUCT DEFINITION,” filed Mar. 8, 2012. The present application also shares some subject matter in common with the following U.S. patent applications, which are incorporated herein by reference for all purposes: U.S. patent application Ser. No. 13/241,467, entitled “OCCURRENCE MANAGEMENT IN PRODUCT DATA MANAGEMENT SYSTEMS,” filed Sep. 23, 2011; and U.S. patent application Ser. No. 13/241,403, entitled “DATA STRUCTURE PARTITIONING IN PRODUCT DATA MANAGEMENT SYSTEMS,” filed Sep. 23, 2011.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

PDM systems manage PLM and other data. Improved systems are desirable.

### SUMMARY OF THE DISCLOSURE

Various disclosed embodiments include systems and methods for collaborative virtual product development. According to disclosed embodiments, a system includes a collaborative design associated with the virtual product. The collaborative design includes a plurality of design elements representing units of data, which include attributes, positions, and geometries of the virtual product. The collaborative design also includes a plurality of partitions defined as a hierarchical organization of the design elements. The collaborative design also references at least one workset comprising a subset of the design elements possessing memberships in the workset based on one or more predetermined rules. The workset is configured to enable a user to interact with the collaborative design. The system includes a search application configured to search the design elements and operable to generate the subset based on the predetermined rules.

According to disclosed embodiments, a method for collaborative virtual product development includes generating a collaborative design associated with the virtual product, the collaborative design including the design elements. The method includes generating a plurality of partitions defined as a hierarchical organization of the design elements in the collaborative design. The method includes generating at least one workset comprising a subset of the design elements possessing memberships in the workset based on one or more predetermined rules. The workset is configured to enable a user to interact with the collaborative design. The method includes searching the design elements to generate the subset based on the predetermined rules.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software, or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system according to disclosed embodiments;

FIG. 2 illustrates a PDM system according to disclosed embodiments;

FIG. 3A illustrates a collaborative product development application according to disclosed embodiments;

FIG. 3B illustrates a collaborative design according to disclosed embodiments;

FIG. 4 illustrates a partitioning scheme according to disclosed embodiments;

FIG. 5A illustrates a subset according to disclosed embodiments;

FIG. 5B illustrates a collaborative design for a vehicle according to disclosed embodiments;

FIG. 6 illustrates a workset according to disclosed embodiments;

FIG. 7 illustrates an organization of a collaborative product design according disclosed embodiments; and

FIG. 8 is a flowchart of a process according to disclosed embodiments.

### DETAILED DESCRIPTION

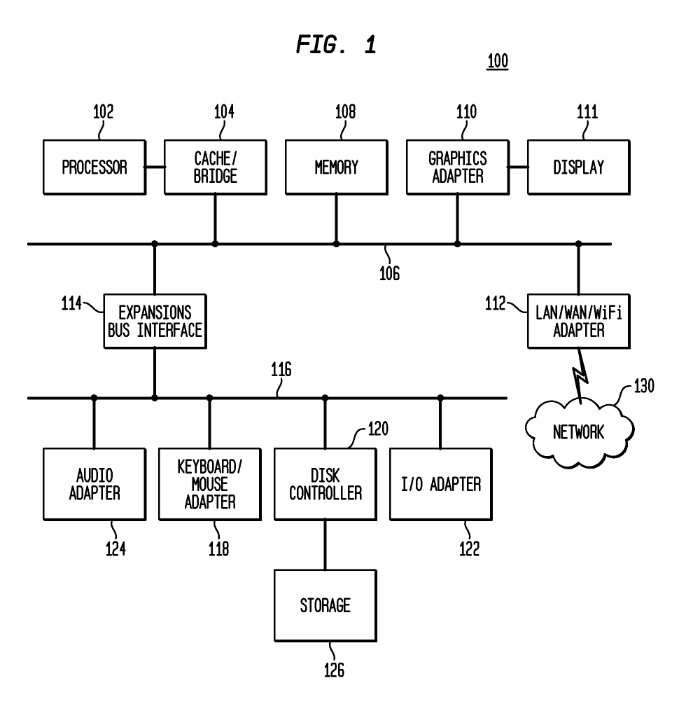

FIGS. 1 through 8, discussed below, and the various embodiments used to describe the principles of the present disclosure in this patent document are by way of illustration only and should not be construed in any way to limit the scope of the disclosure. Those skilled in the art will recognize that the principles of the present disclosure may be implemented in any suitably arranged device or a system. The numerous innovative teachings of the present disclosure will be described with reference to exemplary non-limiting embodiments.

PDM systems are widely used in design and modification of virtual models. Currently available PDM systems are facing technical and business challenges in many industries such as, for example, shipbuilding, automotive, aerospace, and defense where 3-D virtual product designs are typically characterized by large virtual product sizes. In many applications, a 3-D virtual product design may require several million design artifacts. The design artifacts may include virtual 3-D design elements for physical parts and peripheral design artifacts such as welds and datums.

Furthermore, currently available PDM systems have drawbacks because of difficulties in integrating the PDM systems' data management capabilities with assembly based design methodologies. In general, existing virtual product design management is based on assembly representations of physical part breakdowns, which lacks desired performance and concurrence characteristic.

According to disclosed embodiments, a PDM system for collaborative virtual product development provides improved flexibility and productivity for large product designs. Also, the PDM system according to disclosed embodiments provides increased concurrency and collaboration. Various embodiments include concurrent user access to virtual 3-D product definition, end user work sessions with ad-hoc subsets of design, data managed independent of a product assembly structure and multiple hierarchical views to allow for multi-disciplinary representations of design data.

FIG. 1 illustrates a block diagram of data processing system 100 in which an embodiment can be implemented, for example as a PDM system particularly configured by software or otherwise to perform the processes as described herein, and in particular as each one of a plurality of interconnected and communicating systems as described herein. The data processing system includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware illustrated in FIG. 1 may vary for particular implementations. For example, other peripheral devices, such as an optical disk drive and the like, also may be used in addition or in place of the hardware depicted. The illustrated example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

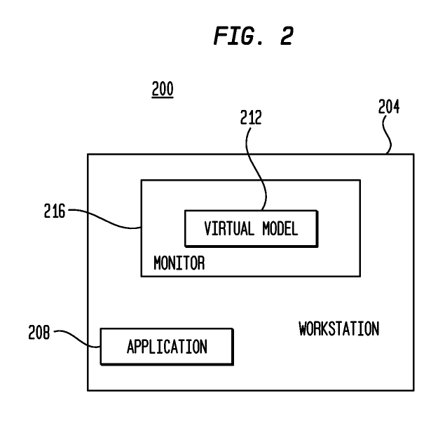

FIG. 2 illustrates PDM system 200 according to disclosed embodiments. PDM system 200 comprises computer workstation 204 which includes collaborative product development application 208. Workstation 204 may be implemented by data processing system 100 as described above. A user may utilize collaborative product development application 208 to create virtual model 212, which may be graphically displayed on monitor 216 connected to workstation 204.

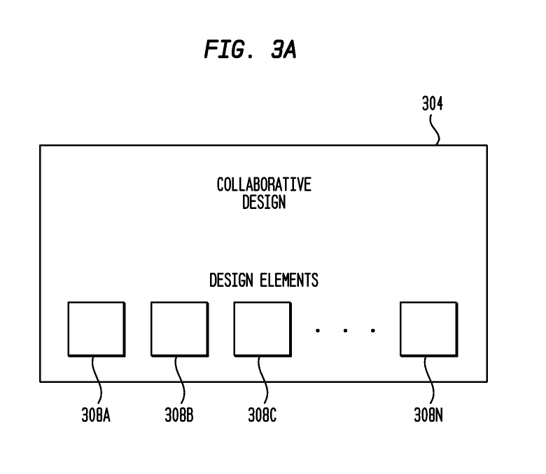

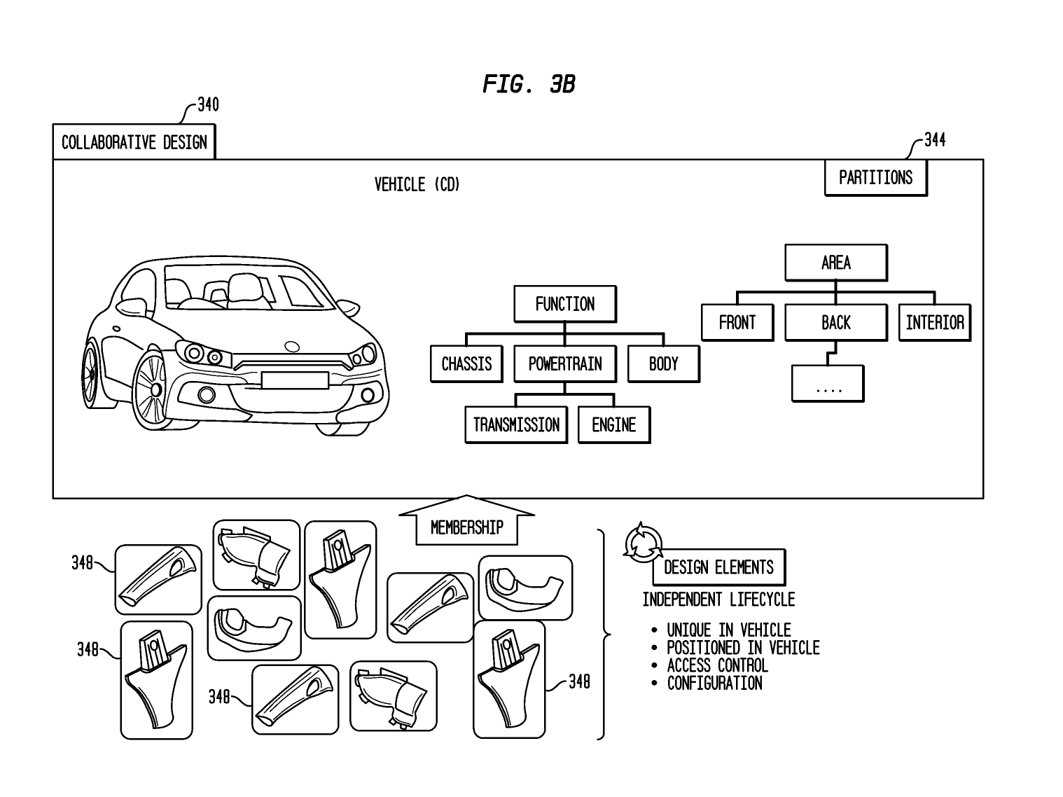

FIG. 3A illustrates collaborative product development application 208 according to disclosed embodiments. Application 208 includes collaborative design 304 comprising a plurality of design elements 308A-308N. Collaborative design 304 may be a virtual model of, for example, a ship, an automobile, or any other product.

Design elements 308A-308N, which are also referred to as “design data”, may be units of data representing geometry of a part, an object, or an instance. It will be appreciated that an instance is an occurrence or a copy of an object.

According to disclosed elements, the design elements are reusable data structures, which may represent parts and assemblies, logical systems, fasteners, welds, or other features of the design. A single design element may be instantiated many different times in a structure. Each instantiation represents a different usage of the same identically defined element and is referred to as an “occurrence” of that design element. For example, a car may have four identical wheels. There is a single definition of the wheel, but it is instantiated four times in the product structure of that car. There are therefore four occurrences in the car corresponding to the front left, front right, rear left, and rear right wheels. Other occurrences may be defined in terms of options and variants for particular configurations.

The ability to model each occurrence explicitly and associate unique data to it while retaining the cohesiveness of the common definition element provides advantages in product structure management. The powerful features supported by an occurrence based model include the ability to define and scope specific information about the usage of an element to the exact context it applies and to work within nested contexts that override data from lower level to higher level contexts.

Occurrences exist in some context, and so “context” is used to refer to the root note in a data structure of the product. For example a front left wheel belongs to the car context, whereas a left wheel might belong to an axle assembly context. Data associated to an occurrence is contextual and effectively “belongs” to the context. An occurrence, as used herein, represents a path through such a product data model of an assembly to a specific node in its proper context, including all parent nodes. In some implementations, an occurrence is concatenation of the occurrences in all nested contexts with suitable override rules applied in a precedence order.

Various disclosed embodiments resolve contention by delegation of control to individual occurrences or groups of occurrences. Thus, the disclosed embodiments allow multiple users to access occurrences of the same referenced item concurrently. The disclosed embodiments allow occurrence data to be managed similar to other workspace objects by providing independent access control, workflow, checkout, release, etc. The disclosed embodiments can bypass organizational hierarchy in occurrences, CAD assembly update, and visualization traversal algorithms to reduce overhead and improve performance. The disclosed embodiments enable subsets of a product's occurrences to be viewed without a full expansion from the top level product context, i.e., provide the ability to understand the context of work based on working with a lower level node when the parents or grandparents are not visible or loaded. The disclosed embodiments allow users to search and filter intelligently and quickly rather than just expand a tree to find their data. The disclosed embodiments allow search (spatial and attribute based search) and partition breakdowns in order to quickly identify a subset of occurrence data relevant to the task at hand.

Referring again to FIG. 3A, design elements 308A-308N may be used by designers to create the virtual model of a product. According to disclosed embodiments, application 208 provides search functionality for searching the design elements. For example, application 208 may include program code configured to search the design elements based on their location, proximity, or attributes. Thus, a user responsible for designing a specific section of a product may quickly locate the relevant design elements in collaborative design 304 by location or proximity search. According to disclosed embodiments, design elements 308A-308N may be stored as standard parts in a catalog and may be re-used as needed in the product design or re-design. Design elements 308A-308N may be locked by restricting access to only authorized users. Thus, the disclosed embodiments increase design concurrency by locking the design elements rather than an entire assembly. This allows multiple users to concurrently work on different design elements of the same assembly.

According to disclosed embodiments, a state of collaborative design 304 may be defined by revisions and variations of design elements 308A-308N. Design elements 308A-308N may have independent lifecycle control and may define their membership in collaborative design 304 in terms of respective positions and configurations.

FIG. 3B illustrates a collaborative design 340 for vehicle 344. Design elements 348 have membership in collaborative design 340. According to disclosed embodiments, the representation of the in-context 3D design is independent from the product breakdown, i.e., the physical assembly breakdown of the product. The design elements can make up the 3D product definition of the overall product in an absolute fashion, i.e., the definition of the in-context design can hold onto an absolute spatial position and statement of applicability (effectivity and variant condition). Also, the design elements provide direct access control and lifecycle-management to the in-context design definition, as opposed to merely functioning as interim nodes to part of the physical product breakdown. Any collection of design elements makes up a consistent collection of 3D design data, i.e., the absolute representation of the in-context design does not rely on how it is being presented to the end user.

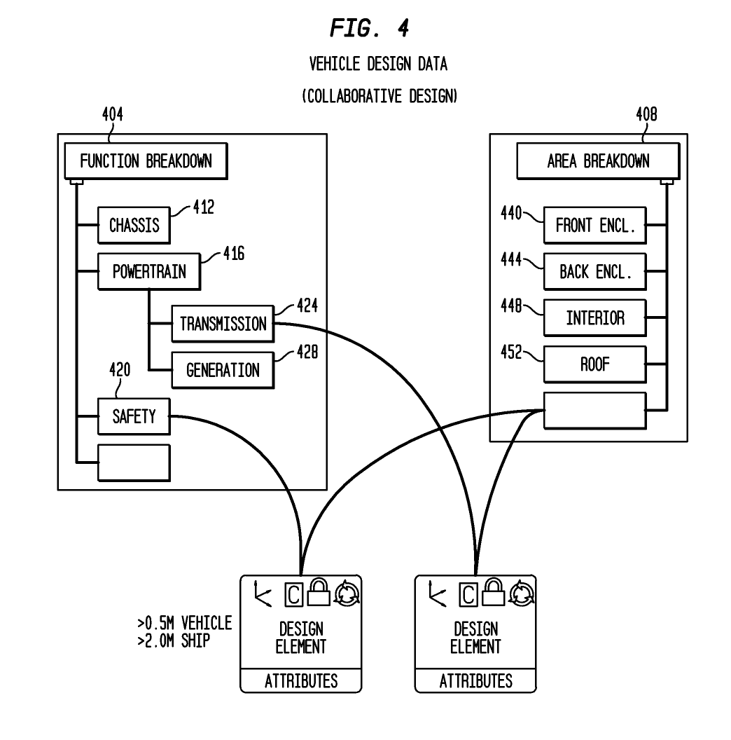

According to disclosed embodiments, the design elements in a collaborative design may be hierarchically organized into a plurality of partitions based on one or more criteria. FIG. 4 illustrates an example partitioning scheme of the design elements for a vehicle based on two criteria: function 404 and area 408. The design elements having membership in function 404 are selected based on their general function while those having membership in area 408 are selected based on their location in a vehicle. It will be appreciated that the design elements may be partitioned based on many other criteria (e.g., module, system). The partition function 404 contains design elements that are used in chassis 412, powertrain 416, and safety 420. The design elements in powertrain 416 may be further divided into transmission 424 and generation 428. The partition area 408 contains design elements used in front 440, back 444, interior 448, and roof 452.

According to disclosed embodiments, the organization of the in-context design data occurs independently from the physical breakdown through the notion of a partition scheme with associated partitions. Partitions provide a grouping mechanism, which provides a view specific presentation of the in-context design data. The presentation of partition content of in-context data can be driven by the user explicitly grouping content together or implicitly defining this through search criteria associated with partition. Given that design elements describe the in-context design intent in an absolute fashion, the end user can organize their design in anyway without compromising any coherence and consistency. A design element can participate in many partitions without its identity in the context of the product design being compromised. Critical attributes like its identity, name, and other associated data does not change.

According to disclosed embodiments, a design element may have membership in more than one partition. A membership in a partition may be dynamic, static, or rule-based. It will be appreciated that the partitioning scheme creates a flexible organization of the design data, which provides ease of use and improves design stability. Also, the partitioning scheme allows data to be organized in a manner suitable for users and tasks. According to disclosed embodiments, the partitioning scheme may be modified without impacting the overall design. Thus, design elements may, for example, be provided memberships to additional partitions without impacting the overall design.

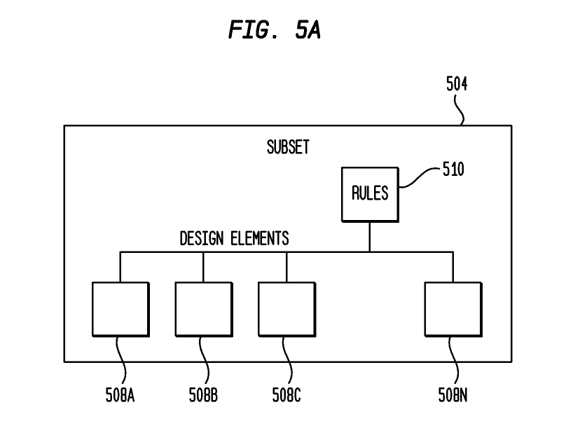

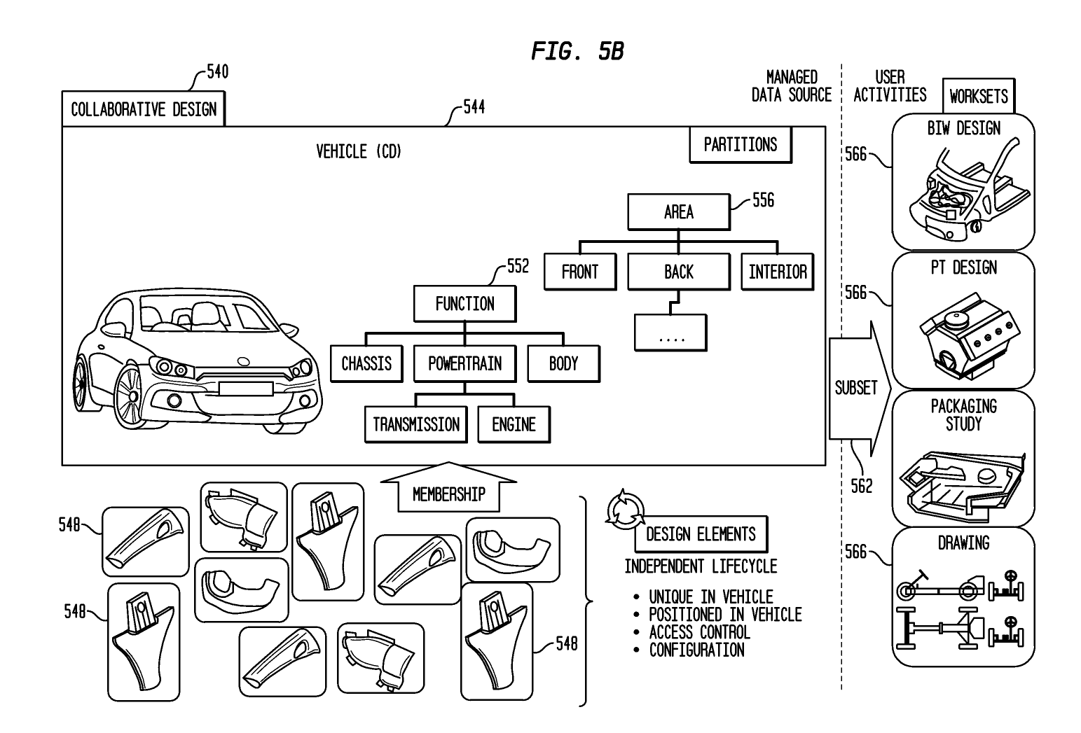

According to disclosed embodiments, a subset is defined as an ad-hoc collection of design elements. A subset may be a collection of design elements based on predetermined rules such that, when configured, the subset yields a precise definition of design elements. FIG. 5A illustrates subset 504 comprising design elements 508A-508N. The design elements 508A-508N are selected using predetermined rules 510. Predetermined rules 510 may be based on attributes, spatial information, or other criteria. According to disclosed embodiments, one or more rules may be combined using Boolean logic to form compound search expressions. According to disclosed embodiments, a subset may be included as an instance in a collaborative design or a workset.

According to disclosed embodiments, in independently managed in-context design data, ad-hoc selection of in-context data may be extracted for single used design activities. As opposed to traditional design data management where the system has to use the physical product structure breakdown to be able to present a correctly configured collection of in-context data, the subset allows the user to prune any 3D design definition from the overall product context (collaborative design) without compromising the design integrity and intent. The subset can prune any in-context design data by either explicit user selection or by a search (e.g., attribute or spatial query). The resulting subset of design elements can be referenced by a workset, which represents the end user working context for any design activities. The workset in addition allows the user to reference multiple ad-hoc collection of in-context design from multiple product contexts. Thus, the user can perform analysis and integration tasks for 3D design spanning multiple product definition. FIG. 5B illustrates collaborative design 540 for vehicle 544. Design elements 548 have membership in collaborative design 540. Design elements may be partitioned based on function 552 and area 556. Subsets 562 may be formed which become worksets 566 for a user.

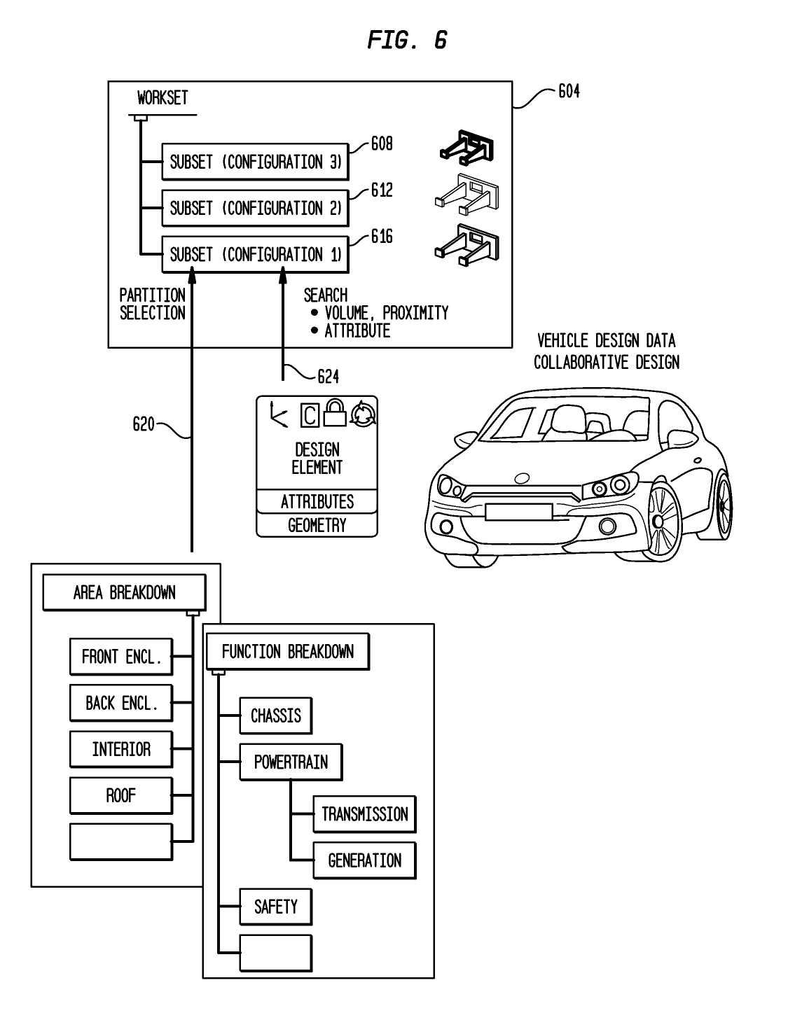

According to disclosed embodiments, a workset is defined as configured subsets of design elements. The constituent design elements in a workset may be selected using a partition. Also, the constituent design elements may be selected by a volume, a proximity, or an attribute search. FIG. 6 illustrates workset 604 comprising subsets 608, 612, and 616. The subsets in workset 604 may be configured based on partition 620 or using search functionality 624.

According to disclosed embodiments, workset 604 is a persistent context and origin for its contents (i.e., constituent design elements). The contents of a workset do not have independent life-cycle control because they are managed by the workset. Thus, a workset is primarily a single user construct, i.e., the workset cannot be concurrently accessed by multiple users. However, according to disclosed embodiments, multiple users may interact with the workset based on applicable access rights. According to disclosed embodiments, a configuration state of a workset upon retrieval is the state it was saved.

According to disclosed embodiments, a workset may be set up for a design session or a mockup study. The workset may be set up using search functionalities of PDM system 200, which allows a user to load only the data that is of interest.

According to disclosed embodiments, the selection of ad-hoc design elements from the 3D design product context is defined by a visual interaction with the end user. Instead of traditional search paradigms whereby the user has to specify text input for search criteria, the subsets provide the user with 3D graphical visual constructs build up based on the desired search criteria. Through the 3D graphical definition of bounding boxes and selection of existing design constructs, the user is able to build up the search criteria required to get a proper collection of in-context design for the task at hand. In addition, the user gets immediate 3D visual feedback for any search criteria being executed in the database. The definition of the search criteria can be always kept in sync by the system with any operations the user performs in the 3D graphical area of the system.

Various disclosed embodiments provide a spatial search for in-context design data. 3D spatial search algorithms allow searching of absolute in-context design making use of bounding box and tessellated 3D design representations. Instead of the traditional search algorithms that use assembly-based representation of the physical product breakdown, the search algorithms according to disclosed embodiments allow for efficient searches of absolute in-context design data.

Various disclosed embodiments provide for configuration of in-context design variability in combination with in-context design history. The configuration of the in-context design may be based on the maturity, effectivity, and variant options as specified by the end user. In addition to the traditional PLM configuration based on the previously enumerated values, the in-context component-based representation of the 3D product definition allows for a historic configuration of its context. The historic configuration allows the end user to configure for a date in the past and understand how the in-context product design looked like at the time of the given date of historic business milestone. Once the user has selected a historic configuration date or milestone, the system allows for the configuration of the in-context design based on effectivity or a variant option set applicable for that historic time slice.

Various disclosed embodiments enable users to model large and complex products including those products with relatively flat structures. The disclosed embodiments facilitate concurrent engineering, decreased cycle time for engineering changes and conformance to auditory standards. Changes to product lifecycle data are controllable and traceable at a suitable level of granularity to support a customer's data security and data integrity requirements.

According to disclosed embodiments, the component-based lifestyle representation of 3D product design in accordance with disclosed embodiments can be represented by features which enable the 3D in-context design to be revised independently from the out of context representation and which enable any 3D in-context design be ad-hoc selected without compromising the integrity of the design.

According to disclosed embodiments, the use of partitions in combination with a virtual 3D design definition may be represented by features which create multiple partition schemes to define possible views or that the in-context design content members of a partition are able to preserve their critical features like ID, name, revision, status, etc., independent of what partition scheme they participate in.

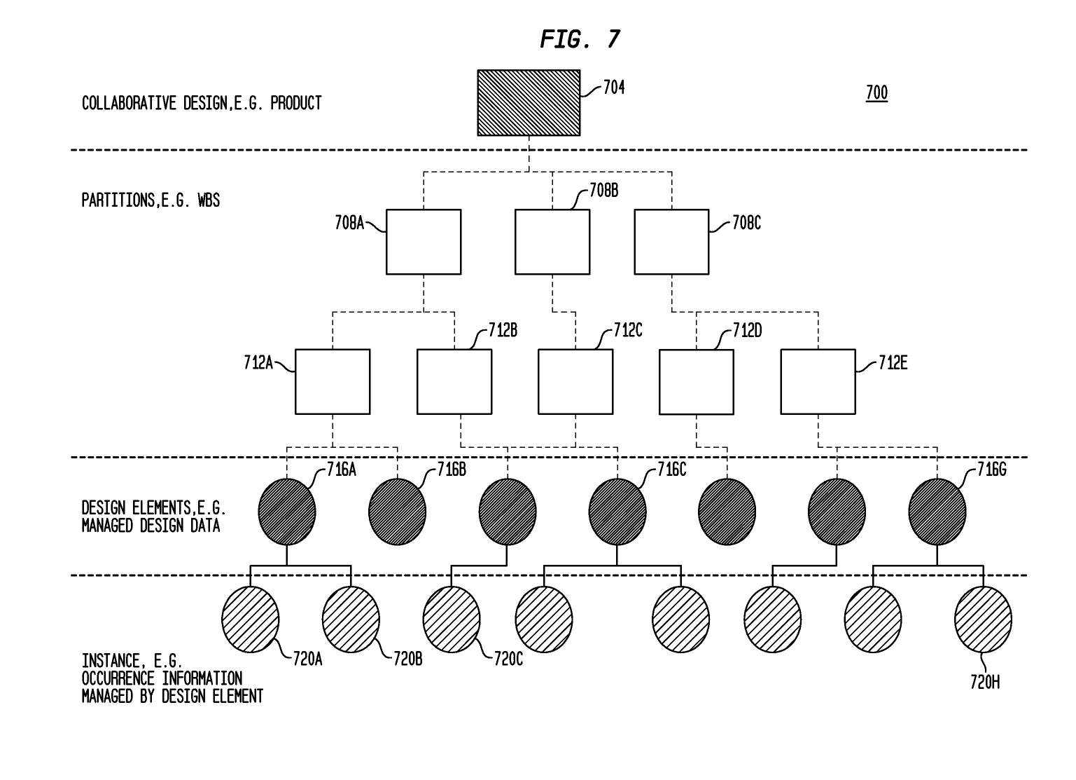

FIG. 7 illustrates an example organization of a collaborative virtual product development 700. In FIG. 7, solid lines are used to represent the delegation of lifecycle management in an occurrence based structure and dashed lines are used to represent organizational structure relationships according to disclosed embodiments. Design elements and instances express their location and configuration information relative to collaborative design. Referring to FIG. 7, collaborative virtual product 700 includes collaborative design 704 associated with a product, which may be partitioned into a plurality of partitions 708A-708C and sub-partitions 712A-712E.

Design elements 716A-712E have membership in the partitions. As illustrated in FIG. 7, a design element may have membership in more than one partition. It will be appreciated that the design elements are managed design data. The design elements can have instances 720A-720H. It will be appreciated that instances are occurrences of the managed design data.

According to disclosed embodiments, system 200 provides rules based sub-setting of data, thereby allowing easy setup of design sessions using search and partition selection. The subsets ensure that a user only load the data of interest, not all data and then hide the data.

By way of example, contents of a ship may be partitioned as follows:

System: An organizational breakdown of systems and sub-systems such as, for example, fresh water system, electrical system, and HVAC system.

Area: An organizational breakdown by location or zone such as, for example, deck and specific room.

Module: An organizational breakdown by modules and sub-modules: For ships constructed in a modular manner, modules are first constructed independently and then combined together in a final assembly.

Work Breakdown: An organizational breakdown of systems and sub-systems used to define and group a project's discrete work elements in a way that organizes and defines the scope of the project.

According to disclosed embodiments, the partitions are orthogonal views into the same set of CAD data. For example, a tank is simultaneously a member of the system breakdown (e.g., freshwater system), the area breakdown (e.g., room), and the module breakdown (e.g., aft module).

According to disclosed embodiments, an occurrence may be promissory if no concrete design is available. The disclosed embodiments provide representation of reusable design and representation of unique design for a specific product. Also, disclosed embodiments provide the ability to load and author occurrences in a CAD system independent from any physical product structure. Also, the disclosed embodiments provide the ability to define multiple hierarchical organizations of occurrences based on attributes and spatial information. The disclosed embodiments provide the ability to reference an occurrence and/or create references between occurrences independent of the organization in the context of a physical product structure.

According to disclosed embodiments, a system for collaborative virtual product development includes a collaborative design associated with the virtual product. The collaborative design includes a plurality of design elements representing units of data, wherein the units of data define geometries of the virtual product. A plurality of partitions may be defined as a hierarchical organization of the design elements in the collaborative design. The collaborative design includes at least one workset comprising a subset of the design elements possessing memberships in the workset based on one or more predetermined rules. The workset is configured to enable a user to modify the collaborative design. The system includes a search application configured to search the design elements and operable to generate the subset based on the predetermined rules.

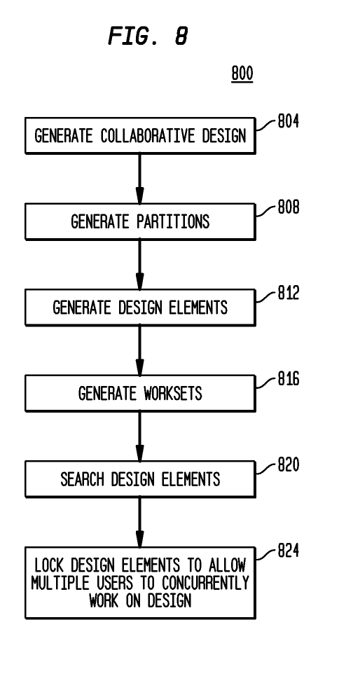

FIG. 8 is a flowchart of a process according to disclosed embodiments. Such a process can be performed, for example, by system 200 as described above, but the “system” in the process below can be any apparatus configured to perform a process as described.

In block 804, system 200 generates a collaborative design for the virtual product. In block 808, system 200 generates a plurality of partitions. Partitions are defined as a hierarchical organization of the design elements in the collaborative design.

In block 812, system 200 generates a plurality of design elements. In block 816, system 200 generates at least one workset comprising a subset of the design elements.

The membership in the workset may be based on one or more predetermined rules. In block 820, system 200 searches the design elements to generate the subset based on the predetermined rules. In block 824, system 200 locks one or more design elements to enable multiple users to concurrently work on the virtual product design. The design elements are stored in a memory.

According to disclosed embodiments, a non-transitory computer-readable medium is encoded with computer-executable instructions for collaborative virtual product development. The computer-executable instructions when executed cause at least one data processing system to: generate a collaborative design for the virtual product, the collaborative design including the design elements; generate a plurality of partitions defined as a hierarchical organization of the design elements in the collaborative design; and generate at least one workset comprising a subset of the design elements possessing memberships in the workset based on one or more predetermined rules, the workset configured to enable a user to modify the collaborative design; and search the design elements to generate the subset based on the predetermined rules.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A system for collaborative virtual product development, comprising:
at least one processor;
a memory connected to the processor;
a collaborative design representing a virtual product, the collaborative design comprising:
a plurality of design elements stored in the memory, wherein the design elements represent units of data;
a plurality of partitions generated by the processor, the partitions defined as a hierarchical organization of the design elements in the collaborative design; and
at least one workset generated by the processor, the workset comprising a subset of the design elements possessing membership in the workset based on one or more predetermined rules, the workset configured to enable a user to modify the collaborative design,
wherein the processor is configured to search the design elements and operable to generate the subset based on the predetermined rules, and wherein the design elements are stored in the memory.

2. The system of claim 1, wherein the subset is defined by at least one of the partitions.

3. The system of claim 1, wherein the subset is defined by attributes of the design elements.

4. The system of claim 1, wherein the subset is defined by a spatial position of the design elements on the virtual product.

5. The system of claim 1, wherein the subset is defined by a mutual proximity of the design elements.

6. The system of claim 1, wherein the partition is defined by a function.

7. The system of claim 1, wherein the partition is defined by a spatial position of the design elements on the virtual product.

8. The system of claim 1, wherein at least one of the design elements has membership in at least two of the partitions.

9. The system of claim 1, wherein at least one of the design elements has membership in at least two of the partitions.

10. The system of claim 1, wherein a state of one or more of the design elements is defined by a latest revision of the design elements.

11. The system of claim 1, wherein the workset is modified by revising the design elements having membership in the collaborative design.

12. The system of claim 1, wherein one or more of the design elements are locked to enable modifications to the virtual product.

13. The system of claim 1, wherein a plurality of users can concurrently modify the virtual product by locking one or more of the design elements and modifying the locked design elements.

14. A method for collaborative virtual product development, comprising:
generating a collaborative design representing a virtual product, the collaborative design including a plurality of design elements;
generating a plurality of partitions defined as a hierarchical organization of the design elements in the collaborative design;
generating at least one workset comprising a subset of the design elements possessing memberships in the workset based on one or more predetermined rules, the workset configured to enable a user to modify the collaborative design; and
searching the design elements to generate the subset based on the predetermined rules.

15. The method of claim 14, further comprising defining the subset by at least one of the partitions.

16. The method of claim 14, further comprising defining the subset by attributes of the design elements.

17. The method of claim 14, further comprising defining the subset by a spatial position of the design elements on the virtual product.

18. The method of claim 14, further comprising defining the partition by a function.

19. The method of claim 14, further comprising defining the partition by a spatial position of the design elements on the virtual product.

20. The method of claim 14, wherein at least one of the design elements has memberships in at least two of the partitions.

21. The method of claim 14, wherein at least one of the design elements has memberships in at least two of the worksets.

22. The method of claim 14, wherein a state of one or more of the design elements is defined by a latest revision of the design elements.

23. The method of claim 14, wherein one or more of the design elements are locked to enable modifications to the virtual product.

24. The method of claim 14, wherein a plurality of users can concurrently modify the virtual product by locking one or more of the design elements and modifying the locked design elements.

25. A data processing system for collaborative virtual product development, comprising:
at least one processor;
a memory connected to the processor, wherein the data processing system is configured to:
generate a collaborative design representing a virtual product, the collaborative design including a plurality of design elements;
generate a plurality of partitions defined as a hierarchical organization of the design elements in the collaborative design; and
generate at least one workset comprising a subset of the design elements possessing memberships in the subset based on one or more predetermined rules, the workset configured to enable a user to modify the collaborative design;
search the design elements to generate the subset based on the predetermined rules; and
store the collaborative design, the worksets and the partitions in the memory.

26. A non-transitory computer-readable medium encoded with computer-executable instructions for collaborative virtual product development, wherein the computer-executable instructions when executed cause at least one data processing system to:
generate a collaborative design associated with a virtual product, the collaborative design including a plurality of design elements;
generate a plurality of partitions defined as a hierarchical organization of the design elements in the collaborative design; and
generate at least one workset comprising a subset of the design elements possessing memberships in the workset based on one or more predetermined rules, the workset configured to enable a user to modify the collaborative design; and
search the design elements to generate the subset based on the predetermined rules.
